(19) United States
(12) Patent Application Publication
(10) Pub. No.: US 2011/0248518 A1
(43) Pub. Date: Oct. 13, 2011

(54) Clutch Mechanism for Outer Handle Device of Door Lock

(76) Inventor: Hung-Jen Tien, Shanhua Township (TW)

(21) Appl. No.: 12/755,516

(22) Filed: Apr. 7, 2010

(51) Int. Cl. E05B 3/00

(52) U.S. Cl. 292/336.3

(57) ABSTRACT

An outer handle device includes an outer handle having a shank with an end face. A clutch block is slideably received in a chamber formed in the end face along an axis but not rotatable relative to the outer handle about the axis. A spindle is rotatably received in the chamber. A protrusion and an engaging groove are respectively formed in the clutch block and a portion of the spindle. When the spindle is in a locked, not rotatable state, the clutch block rotates jointly with the outer handle while the outer handle is rotated for moving a latch from a latching position to an unlatching position. The clutch block also slides relative to the outer handle along the axis to disengage the protrusion from the engaging groove, disengaging the clutch block from the spindle such that the spindle is not rotated and that the latch remains in the latching position.

### BACKGROUND OF THE INVENTION

The present invention relates to a clutch mechanism for an outer handle device of a door lock and, more particularly, to a clutch mechanism for an outer handle device of a door lock allowing free rotation of an outer handle when the door is in a locked state.

Door locks with a clutch mechanism have been developed to allow free rotation of an outer handle when the door lock is in a locked state. However, the internal components of the door lock could still be damaged if the force applied to the outer handle exceeds a certain extent. In an approach to avoid damage to the internal components of the door lock, a follower actuated by the outer handle is provided with two teeth for actuating the spindle. The teeth will break when excessive force is applied to the outer handle while the door lock is in the locked state such that the outer handle rotates freely without rotating the spindle. However, the lock can not be unlatched by operating the outer handle after the teeth are broken. Troublesome replacement of the follower is, thus, required.

Thus, a need exists for a clutch mechanism for an outer handle device of a door lock that allows free rotation of the outer handle when the door lock is in a locked state without causing damage to any component of the door lock.

### BRIEF SUMMARY OF THE INVENTION

The present invention solves this need and other problems in the field of prevention of damage to components while allowing free rotation of outer handles of door locks by providing, in a preferred form, an outer handle device including an outer handle having a shank extending along an axis. A chamber is formed in an end face of the shank and has an opening in the end face. The chamber includes an end wall spaced from the opening along the axis. The end face of the shank is adapted to rotatably abut an outer face of a cover mounted to an outer side of a door to which a door lock is mounted. The outer handle is rotatable between first and second positions. A spring is received in the chamber and includes front and rear ends spaced along the axis. The rear end of the spring abuts the end wall of the chamber. A clutch block is slideably received in the chamber along the axis but not rotatable relative to the outer handle about the axis. The clutch block includes front and rear faces spaced along the axis. The front end of the spring abuts the rear face of the clutch block. The clutch block rotates jointly with the outer handle when the outer handle rotates between the first and second positions. A spindle is rotatably received in the chamber about the axis. The spindle includes a front spindle section. A coupling section is formed on an end of the front spindle section. The coupling section is adapted to be operably connected to a latch of the door lock. A flange is formed on the other end of the front spindle section and spaced from the coupling section along the axis. The flange includes first and second surfaces spaced along the axis. The latch is in a latching position when the spindle is in an unlocked, rotatable state and when the handle is in the first position. The spindle is moved by the outer handle to move the latch to an unlatching position when the outer handle is rotated from the first position to the second position. A clutch mechanism includes a protrusion and an engaging groove. The protrusion is formed on one of the front face of the clutch block and the other end of the spindle. The engaging groove is formed in the other of the front face of the clutch block and the other end of the spindle. The protrusion is releasably engaged in the engaging groove. A stop is received in the opening of the chamber. The stop abuts the flange to prevent the spindle from moving away from the end wall along the axis.

When the spindle is in the unlocked, rotatable state, the protrusion is engaged in the engaging groove while the outer handle is rotated from the first position to the second position. The clutch block rotates jointly with the outer handle about the axis and drives the spindle to rotate about the axis, moving the latch from the latching position to the unlatching position.

When the spindle is in a locked, not rotatable state, the clutch block rotates jointly with the outer handle while the outer handle is rotated from the first position to the second position. The clutch block also slides relative to the outer handle towards the end wall along the axis to disengage the protrusion from the engaging groove, disengaging the clutch block from the spindle such that the spindle is not rotated and that the latch remains in the latching position.

In a preferred form, the protrusion is formed on the second surface of the flange, and the engaging groove is formed in the front face of the clutch block. In another preferred form, the clutch block includes a through-hole extending from the front face through the rear face of the clutch block. The spindle further includes a rear spindle section. The flange is intermediate the front and rear spindle sections. The rear spindle section extends through the through-hole of the clutch block and abuts the end wall, preventing the spindle from moving towards the end wall along the axis.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a partial, exploded, perspective view of a door lock including an outer handle device according to the preferred teachings of the present invention.

FIG. 2 shows a partial, exploded, perspective view of the outer handle device of FIG. 1.

FIG. 3 shows an exploded, perspective view of a returning device of the door lock of FIG. 1.

FIG. 4 shows a cross sectional view of a door and the door lock of FIG. 1 with the door lock in a latched state.

FIG. 5 shows a cross sectional view according to section line 5-5 of FIG. 4.

FIG. 6 shows a cross sectional view according to section line 6-6 of FIG. 5.

FIG. 7 shows a partial, enlarged view of the door lock of FIG. 1 according to section line 7-7 of FIG. 4.

FIG. 8 is a view similar to FIG. 2, with the door lock in an unlatched state.

FIG. 9 shows a cross sectional view according to section line 9-9 of FIG. 8.

FIG. 10 shows a partial, enlarged cross sectional view of the door lock of FIG. 1 according to section line 10-10 of FIG. 8.

FIG. 11 shows a view similar to FIG. 5 with a shank of the outer handle device in a locked state.

FIG. 12 shows an enlarged view of a portion of the door lock of FIG. 11 with the outer handle rotated.

FIG. 13 shows a cross sectional view according to section line 13-13 of FIG. 12.

FIG. 14 shows a partial, exploded, perspective view of the outer handle device of a modified embodiment according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “lower”, “upper”, “inner”, “outer”, “front”, “rear”, “side”, “end”, “portion”, “section”, “axial”, “lateral”, “horizontal”, “vertical”, “annular”, “inward”, “spacing”, “clockwise”, “counterclockwise”, “length”, “height”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

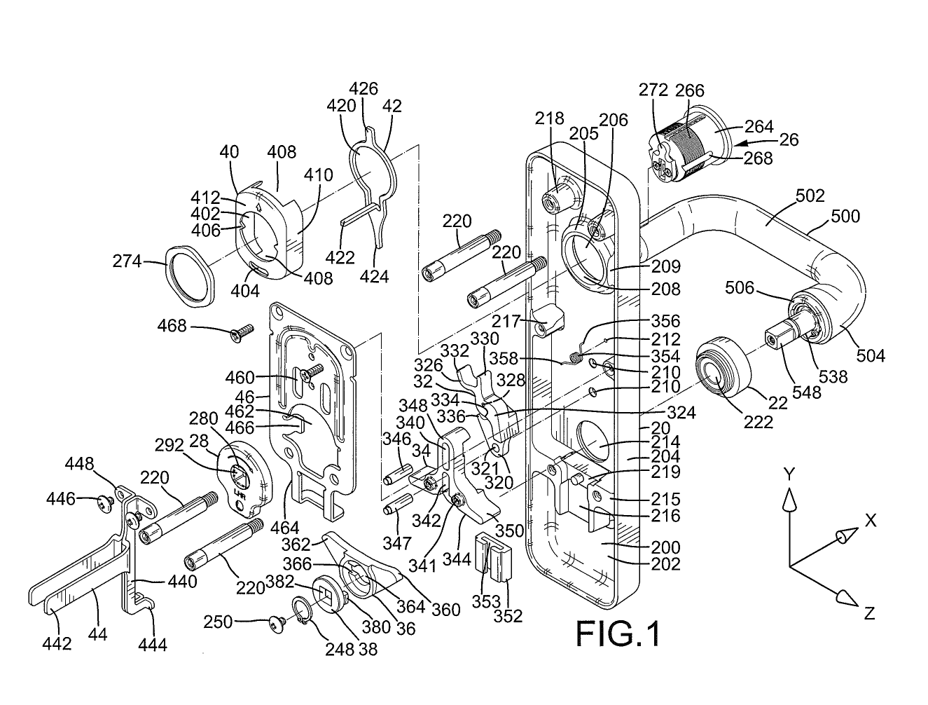

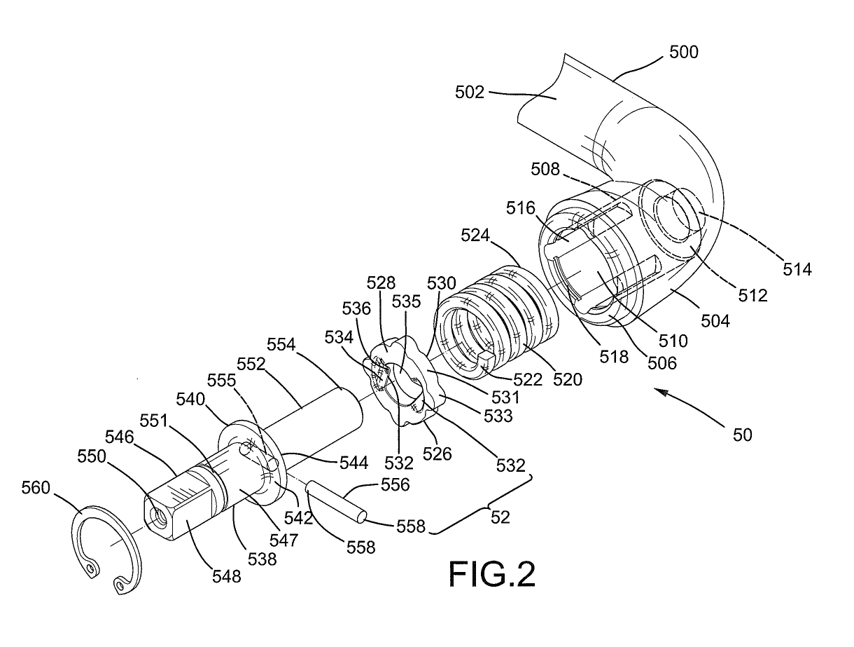

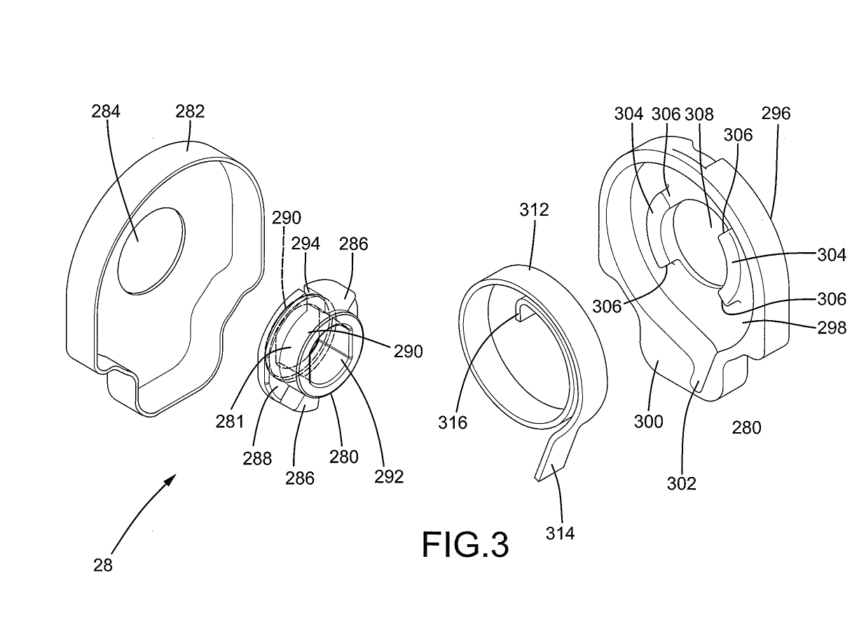

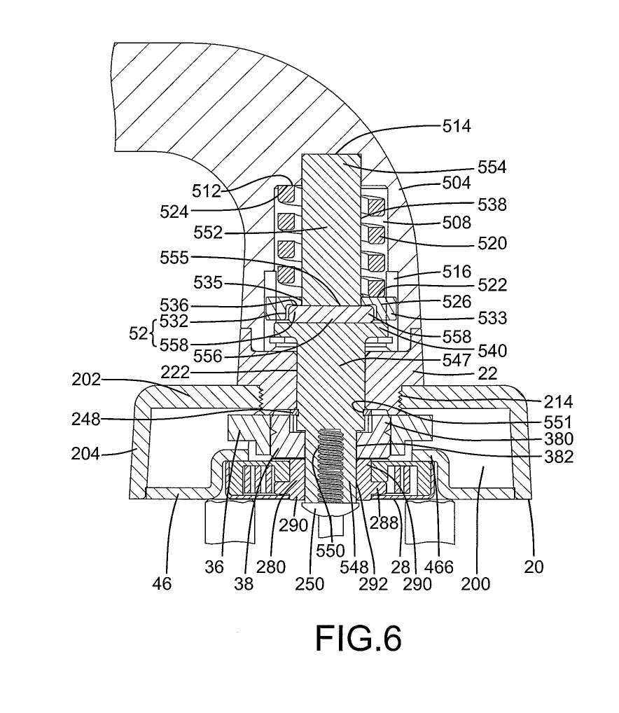

An outer handle device 50 according to the preferred teachings of the present invention is shown in the drawings and adapted to be utilized in an outer operational device of a door lock mounted to a door 10. According to the preferred forms shown in FIGS. 1-14, the door lock includes a follower device 16 and a latch device 12 operably connected to follower device 16. Door 10 is hinged to a door frame 102 and includes an inner side 10a and an outer side 10b spaced from inner side 10a along a first axis X. It is noted that inner and outer sides 10a and 10b are exchanged when door 10 is installed as a differently handed door. Furthermore, door 10 includes a mounting hole 106 extending from inner side 10a through outer side 10b. Door frame 102 includes top and bottom strikers 104 (only top striker 104 is shown) spaced along a second axis Y perpendicular to first axis X and perpendicular to the ground in the most preferred form shown. When door 10 is closed, inner side 10a abuts against an end face of door frame 102. Follower device 16 and latch device 12 are mounted to inner side 10a of door 10, and the outer operational device is mounted to outer side 10b.

According to the preferred forms shown in FIGS. 1-14, follower device 16 includes a base 144 having two slots 146 spaced along second axis Y. A sliding device 14 is mounted in each slot 146. Specifically, each sliding device 14 includes a slide 142 slideably received in one of slots 146. Follower device 16 includes a linking rod 150 that is operably connected to slides 142 by two links 152. Follower device 16 further includes an operative member 162 in the form of a press bar operably connected to linking rod 150. When operative member 162 is pressed, linking rod 150 is moved in an unlatching direction to move links 152 toward each other, which in turn, moves slides 142 toward each other.

According to the preferred forms shown in FIGS. 1-14, latch device 12 includes top and bottom latches 124 (only top latch 124 is shown) spaced along second axis Y. Specifically, latch device 12 includes upper and lower casings 122 in which top and bottom latches 124 are pivotably mounted. A follower 128 is slideably mounted in each casing 122. A connecting rod 126 is mounted between each follower 128 and one of latches 124. Specifically, an end of each connecting rod 126 is pivotably connected to one of latches 124. The other end of each connecting rod 126 is pivotably connected to an end of one of followers 128. The other end of each follower 128 is pivotably connected to an end of a screw rod 130. The other end of each screw rod 130 is threadedly coupled with an end of a coupling rod 132. The other end of each coupling rod 132 is coupled to one of slides 142.

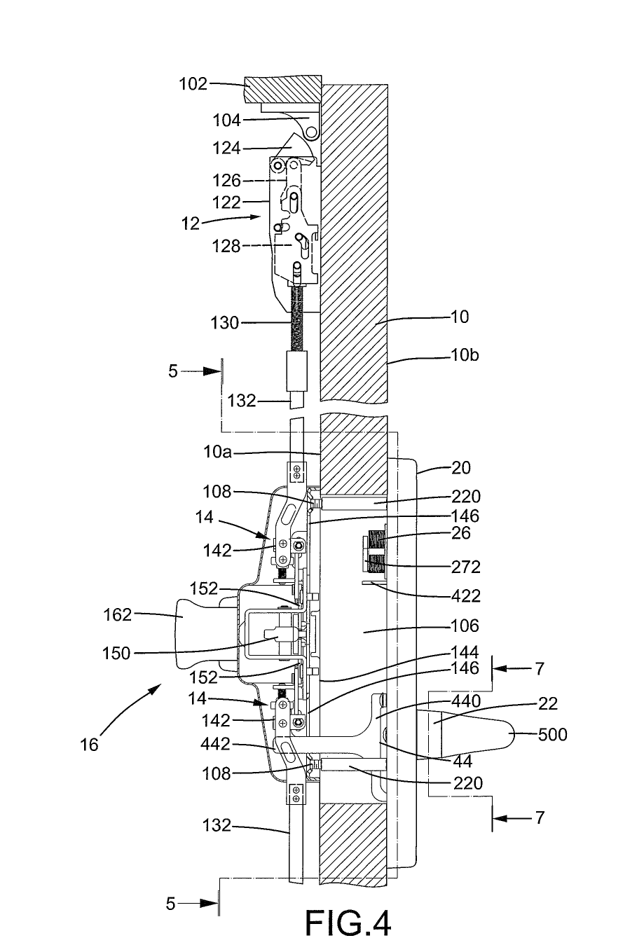

When follower device 16 is not operated, latches 124 are in an extended, locking position outside of casings 122 and abut against strikers 104 (FIG. 4), not allowing opening of door 10. When operative member 162 is operated, slides 142 move toward each other. Coupling rods 132 are moved toward each other to cause movement of followers 128 and connecting rods 126. Thus, latches 124 are pivoted inward to a retracted, unlocking position inside of casings 124 allowing opening of door.

The outer operational device can be operated from outer side 10b of door 10 to move slides 142 for unlocking purposes. According to the preferred forms shown in FIGS. 1-14, the outer operational device includes a cover 20 having a sidewall 202 extending in along second axis Y and an annular wall 204 extending perpendicularly along a periphery of sidewall 202, defining a space 200 between annular wall 204 and sidewall 202. Sidewall 202 includes a receiving portion 205 in an upper portion thereof. Receiving portion 205 extends into space 200 along first axis X and forms a compartment 206. Furthermore, receiving portion 205 includes two parallel, spaced, chamfered faces 209 on an outer periphery thereof. Compartment 206 includes an opening 208 in communication with space 200. Sidewall 202 further includes upper and lower fixing holes 210 below opening 208 along second axis Y. Sidewall 202 further includes an engaging hole 214 below fixing holes 210 and having inner threading. A protrusion 215 extends from an inner face of sidewall 202 below engaging hole 214. Protrusion 215 includes a first groove 216 and a second groove 219 above first groove 216 and shallower than first groove 216 along first axis X. Two pegs 218 are formed on the inner face of sidewall 202 and located above opening 208. Pegs 218 are spaced along a third axis Z perpendicular to first and second axes X and Y. Annular wall 204 includes two supports 217 on two inner, vertical faces thereof. Each support 217 has a height from sidewall 202 along first axis X the same as that of protrusion 215. Sidewall 202 further includes a positioning hole 212 above upper fixing hole 210 along second axis Y.

According to the preferred forms shown in FIGS. 1-14, two mounting posts 220 are engaged with screw holes in pegs 218. Furthermore, two additional mounting posts 220 are engaged with screw holes in protrusions 215. Cover 20 is mounted to outer side 10b of door 10 and covers mounting hole 106, with annular wall 204 abutting outer side 10b and with each mounting post 220 extending through mounting hole 106 to a position adjacent to base 144. A fastener 108 in the most preferred form shown as a screw is extended through base 144 into a screw hole in an end of each mounting post 220, so that base 144 is fixed to inner side 10a of door 10 and that cover 20 is fixed to outer side 10b of door 10.

According to the preferred forms shown in FIGS. 1-14, the outer operational device further includes a sleeve 22 mounted to an outer face of sidewall 202. Sleeve 22 includes a central pivot hole 222 coaxial to engaging hole 214 of cover 20 and to first axis X. Sleeve 22 is threadedly fixed in engaging hole 214 of cover 20.

According to the preferred forms shown in FIGS. 1-14, outer handle device 50 includes an outer handle 500 having a stem 502 adapted to be gripped by a user and a shank 504 extending from an end of stem 502 along first axis X. Shank 504 includes an end face 506 having a chamber 508. Chamber 508 includes an opening 510 in end face 506 and an end wall 512 spaced from opening 510 along first axis X. End wall 512 includes a receptacle 514. An inner periphery of chamber 508 includes four guide grooves 516 each extending from opening 510 and having a length along first axis X about a half of that of chamber 508 along first axis X. The inner periphery of chamber 508 further includes an annular groove 518 adjacent opening 510 and intersecting guide grooves 516.

According to the preferred forms shown in FIGS. 1-14, outer handle device 50 further includes a spring 520 in the form of a coil spring. Spring 520 is received in chamber 508 and includes front and rear ends 522 and 524 spaced along first axis X. Rear end 524 of spring 520 abuts end wall 512.

According to the preferred forms shown in FIGS. 1-14, outer handle device 50 further includes a clutch block 526 received in chamber 508. Clutch block 526 includes front and rear faces 528 and 530 spaced along first axis X and an outer periphery 531 extending between front and rear faces 528 and 530. Outer periphery 531 has a diameter not larger than an inner diameter of chamber 508. Four annularly spaced lugs 533 extend radially from outer periphery 531 of clutch block 526 and are slideably received in guide grooves 516 along first axis X. Clutch block 526 further includes a through-hole 535 extends from front face 528 through rear face 530. Front face 528 includes two diametrically opposed engaging grooves 532 on opposite sides of and in communication with through-hole 535. Each engaging groove 532 includes a bottom wall 536 spaced from front face 528 along first axis X and two inclined faces 534 on opposite sides of engaging groove 532. Each inclined face 534 extends between bottom wall 534 and front face 528. Inclined faces 534 are spaced along a circumferential direction of through-hole 535 such that each engaging groove 532 is substantially V-shaped in cross section. Clutch 526 is slideably received in chamber 508 along first axis X with outer periphery 531 abutting the inner periphery of chamber 508 and with lugs 533 slideably received in guide grooves 516, allowing joint rotation of clutch block 526 and outer handle 500. Front face 528 and engaging grooves 532 of clutch block 526 face opening 510 of chamber 508. Rear face 530 of clutch block 526 abuts front end 522 of spring 520.

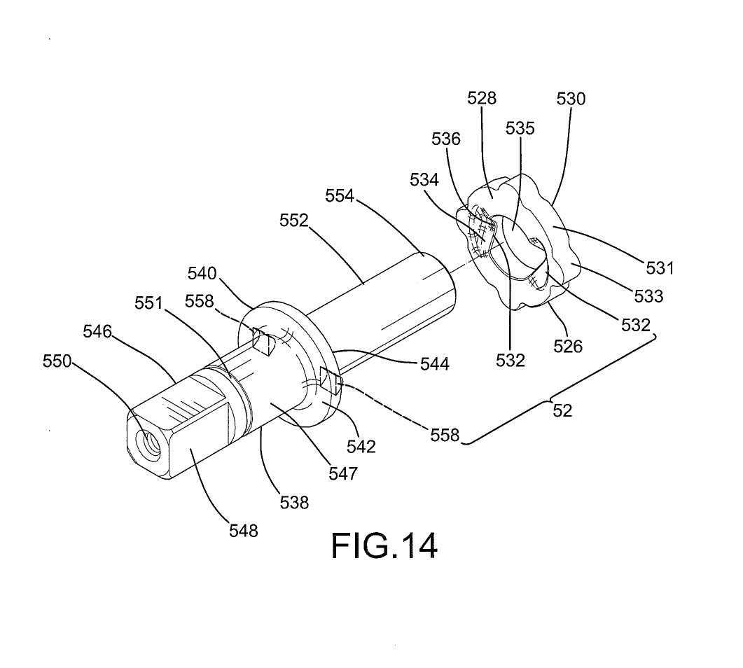

According to the preferred forms shown in FIGS. 1-14, outer handle device 50 further includes a spindle 538 having front and rear handle sections 546 and 552 spaced along first axis X and a flange 540 between front and rear handle sections 546 and 552. Flange 540 includes front and rear surfaces 542 and 544 respectively facing front and rear handle sections 546 and 552. Flange 540 has a diameter larger than that of front handle section 546, which, in turn, is larger than rear handle section 552. Front spindle section 546 includes a cylindrical section 547 adjacent flange 540 and a coupling section 548 distant to flange 540. Coupling section 548 has non-circular cross sections. In the preferred forms shown in FIGS. 1-14, coupling section 548 has square cross sections. Coupling section 548 includes an end face having a screw hole 550 extending along first axis X. Cylindrical section 547 has an annular groove 551. Rear spindle section 552 further includes a distal end 554 distant to flange 540. In the preferred form shown in FIGS. 1-13, rear spindle section 552 includes a diametrical pin hole 555 extending perpendicularly to first axis X and adjacent to second surface 544. A pin 556 having a length smaller than the diameter of flange 540 is extended through pin hole 555 with two ends of pin 556 outside of pin hole 555 forming two protrusions 558 within the extent of flange 540. In the preferred form shown in FIG. 14, outer handle device 50 does not include pin 555, and two diametrically opposed protrusions 558 are directly formed on second surface 544 of flange 540.

In assembly of outer handle device 500, rear spindle section 552 of spindle 538 is inserted into chamber 508 via opening 510 with rear spindle section 552 extending through through-hole 535 of clutch block 526 and spring 520 into receptacle 514 and with distal end 554 abutting against a bottom wall of receptacle 514, avoiding movement of spindle 538 toward end wall 512 along first axis X. Flange 540 is received in chamber 508 and located between annular groove 518 and front face 528 of clutch block 526 along first axis X. Second surface 544 of flange 540 abuts front face 528 of clutch block 526. Protrusions 558 are received in engaging grooves 532. Protrusions 558 and engaging grooves 532 together form a clutch mechanism 52. Front spindle section 546 extends out of shank 504 via opening 510. A stop 560 in the preferred form of a C-ring is mounted in annular groove 518 of outer handle 500 and abuts first surface 542 of flange 540 to prevent spindle 538 from moving away from end wall 512 along first axis X. Since protrusions 558 engage with engaging grooves 532 of clutch block 526, spindle 538 rotates jointly with outer handle 500 when outer handle 500 is rotated. Note that end face 506 of shank 504 rotatably abuts an outer face of sleeve 22. Cylindrical section 547 of front spindle section 546 is rotatably received in pivot hole 222 of sleeve 22 with a portion of cylindrical section 547 extending into space 200. Thus, outer handle 500 can rotate 360° about first axis X.

According to the preferred forms shown in FIGS. 1-14, the outer operational device further includes an actuating member 36 having a connecting hole 364 in an intermediate portion thereof. Two diametrically opposed rectangular grooves 366 are formed in an inner periphery of connecting hole 364. Actuating member 36 further includes first and second ends 360 and 362 on opposite sides of connecting hole 364. The portion of cylindrical section 547 of front spindle section 546 is received in connecting hole 364, and coupling portion 548 of spindle 538 is outside of follower 36.

According to the preferred forms shown in FIGS. 1-14, the outer operational device further includes a follower 38 in the preferred of a ring. Follower 38 includes a non-circular hole 382 having cross sections corresponding to coupling section 548 of spindle 538. Follower 38 further includes two diametrically opposed teeth 380 extending in a direction perpendicular to a central axis of follower 38. Coupling section 548 of spindle 538 is received in non-circular hole 382 of follower 38, and teeth 380 are engaged in grooves 366. Thus, spindle 538 and follower 38 rotate jointly due to non-circular hole 382 and non-circular coupling section 548. Furthermore, since teeth 380 of follower 38 are engaged in grooves 366 of actuating member 36, rotation of spindle 538 also causes rotation of actuating member 36. A retainer ring 248 in the form of a C-clip is mounted in annular groove 551 of front spindle section 546 to prevent axial movement of follower 38 along first axis X.

According to the preferred forms shown in FIGS. 1-14, the outer operational device further includes a guide block 352 received in first groove 216 of cover 20 and having a size corresponding to first groove 216 of cover 20. Guide block 352 includes a sliding groove 353 extending along second axis Y.

According to the preferred forms shown in FIGS. 1-14, the outer operational device further includes an inner lid 46 having an opening 462 through which coupling section 548 of spindle 538 extends. A bend 466 is formed on an inner periphery of opening 462. Inner lid 46 further includes two parallel, spaced, elongated slots 460 above opening 462. Inner lid 46 further includes a support 464 below opening 462. Inner lid 46 abuts protrusion 215 and supports 217, and fasteners 468 are extended through inner lid 46 into screw holes in supports 217. Two of mounting posts 220 are extended through inner lid 46 into screw holes in protrusion 215. Thus, inner lid 46 is fixed in space 200 of cover 20. Support 464 abuts two lateral walls of first groove 216 such that guide block 352 can not move in first groove 216 along first axis X.

According to the preferred forms shown in FIGS. 1-14, the outer operational device further includes a returning device 28 having a body 296 having a non-circular outer periphery. Body 296 includes a lobe 300 on a lower end thereof and having rectangular cross sections. Body 296 further includes a compartment 298 in a side thereof. Compartment 298 forms an engaging groove 302 in lobe 300. A bottom wall defining compartment 298 includes a pivot hole 308. Two limiting blocks 304 are formed on the side of body 296 along a periphery of pivot hole 308. Each limiting block 304 includes two ends 306. Furthermore, each limiting block 304 has a height to the side of body 296 along first axis X smaller than or equal to a depth of compartment 298 along first axis X. A housing 282 slightly larger than body 296 is mounted to the side of body 296 to cover compartment 298. Housing 282 includes an axial hole 284 aligned with pivot hole 308.

According to the preferred forms shown in FIGS. 1-14, returning device 28 further includes a substantially cylindrical rotatable member 280 in the form of a cylinder 281 having a flange 288 on an intermediate portion of an outer periphery thereof. Two pivotal sections 290 are formed on opposite sides of flange 288 and spaced along first axis X. Also formed on the outer periphery of rotatable member 280 are first and second blocks 286 adjacent two ends of flange 288. A slit 294 is formed between flange 288 and first block 286. Rotatable member 280 further includes a non-circular hole 292 through which coupling section 548 of spindle 538 extends. Pivotal sections 290 are respectively and pivotably received in pivot hole 308 of body 296 and axial hole 284 of housing 282 with blocks 286 located between limiting blocks 304. The spacing between limiting blocks 304 and blocks 286 limits rotation of rotatable member 280.

According to the preferred forms shown in FIGS. 1-14, returning device 28 further includes an elastic element 312 in the form of a spiral spring having a spiral section, a first, outer tang 314 outside of the spiral section, and a second, inner tang 316 inside of the spiral section. The spiral section of elastic element 312 is mounted around limiting blocks 304 and located in compartment 298 with first, outer tang 314 abutting against a wall of engaging groove 302 and with second, inner tang 316 received in slit 294 of rotatable member 280 and abutting against a side of first block 286 adjacent slit 294. Thus, first tang 314 is fixed to body 296, and second tang 316 is fixed in slit 294. Rotatable member 280 is biased by elastic element 312 so that each of first and second blocks 286 presses against an end 366 of one of limiting blocks 304. In this state, stem 502 of outer handle 500 is in a horizontal state perpendicular to second axis Y with rotatable member 280 in its initial position. When rotatable member 280 is rotated, first block 286 adjacent slit 294 presses against second tang 316 of elastic element 312 to store the restoring force.

Returning device 28 is received in opening 462 of inner lid 46 and abuts against bend 466. Coupling section 548 of spindle 538 is extended through non-circular hole 292 of rotatable member 280. A fastener 250 is threadedly engaged in screw hole 550 of coupling section 548 and includes a head abutting against rotatable member 280, such that returning device 28 can not move along coupling section 548. Thus, follower 38 and actuating member 36 are retained in place. Due to non-circular coupling between coupling section 548 and rotatable member 280, elastic element 312 is twisted by rotatable member 280 when outer handle 500 is rotated. When outer handle 500 is released, elastic element 312 returns rotatable member 280 to its initial position and returns handle 24 to its initial, horizontal position.

According to the preferred forms shown in FIGS. 1-14, the outer operational device further includes a limiting member 32 received in space 200 and having a substantially triangular pivotal portion 320. Pivotal portion 320 includes a pivot hole 321 coaxial to lower fixing hole 210 after limiting member 32 is mounted in space 200. Pivotal portion 320 includes first and second limiting portions 322 and 336 spaced along third axis Z with a groove 338 formed between first and second limiting portions 322 and 336. A stop 324 is formed on a side of pivotal portion 320 and has a thickness along first axis X larger than that of pivotal portion 320. Stop 324 has a positioning hole 328 in a face thereof. Stop 324 further includes an arcuate stop face 334 facing first limiting portion 322. Further, stop 324 includes a follower portion 326 on an upper end thereof. Follower portion 326 includes first and second protruded portion 330 and 332.

According to the preferred forms shown in FIGS. 1-14, the outer operational device further includes first and second guide pins 346 and 347 mounted in upper and lower fixing holes 210 of cover 20. Pivotal portion 320 of limiting member 32 is pivotably mounted around second guide pin 347. First guide pin 346 is slideably received in groove 338 between first and second limiting portions 322 and 336. A spring 354 includes a first tang 356 received in positioning hole 212 of cover 20 and a second tang 358 received in positioning hole 328 of stop 324.

According to the preferred forms shown in FIGS. 1-14, the outer operational device further includes a substantially T-shaped sliding member 34 having a vertical first section 348 and a substantially horizontal second section 350. First section 348 includes a first guiding groove 340 and a second guide groove 342 below first guiding groove 340 along second axis Y. Each of first and second guiding grooves 340 and 342 has a length along second axis Y substantially the same as that of elongated slots 460 of inner lid 46. Second section 350 includes a connecting portion 341 in the form of two pegs each having a screw hole. Furthermore, second section 350 includes a pressing face 344 at a lower end thereof. Sliding member 34 is slideably received in space 200 of cover 20 with pressing face 344 abutting against first and second ends 360 and 362 of actuating member 36. First guide pin 346 is extended through first guiding groove 340, and second guide pin 347 is extended through second guiding groove 342, so that limiting member 34 can only slide through and limited by the length of first and second guiding grooves 340 and 342 along second axis Y. The pegs of connecting portion 341 are extended into elongated slots 460 of inner lid 40. Provision of first and second guiding grooves 340 and 342 prevent rotation of sliding member 34 during sliding movement. When rotatable member 280 rotates to a position abutting against the other limiting block 304, actuating member 36 rotates, with one of first and second ends 360 and 362 (depending on the rotating direction of actuating member 36) pushes sliding member 34 upward to an upper position. When first and second ends 360 and 362 of actuating member 36 are at the same level, sliding member 34 is in its lower position.

According to the preferred forms shown in FIGS. 1-14, the outer operational device further includes a substantially T-shaped driving member 44 having a base portion 440 extending along second axis Y and a rod 442 extending from an intermediate section of base portion 440 along first axis X. An upper end of base portion 440 is bent to form an engaging portion 448. A lower end of base portion 440 includes a guiding portion 444 that has a shape corresponding to sliding groove 353 of guide block 352 and that is aligned with connecting portion 341 of sliding member 34. Two fasteners 446 are extended through holes in engaging portion 448 and elongated slots 460 of inner lid 46 into the screw holes of the pegs of connecting portion 341 of sliding member 34. Guiding portion 444 is extended into sliding groove 353 of guide block 35. Thus, driving member 44 and sliding member 34 can move jointly. Elongated slots 460 of inner lid 46 allow movement of fasteners 446. Sliding groove 353 allows stable sliding of guiding portion 444 when rod 442 is subjected to a torque. Rod 442 extends through mounting hole 106 of door 10 and slot 146 of base 144 of follower device 16 to a position below a lower one of slides 142.

According to the preferred forms shown in FIGS. 1-14, the outer operational device further includes a cylinder 26 including a cylindrical body 264. A front end of an outer periphery of body 264 includes a threaded portion 266. The outer periphery of body 264 further includes two diametrically opposed V-shaped positioning grooves 268. A lock core 270 is received in body 264. An actuator 272 is provided on the other end face of body 264 and fixed to lock core 270 to rotate therewith. Cylinder 26 is received in compartment 206 of cover 20. Body 264 is extended through opening 208 into mounting hole 106 of door 10.

According to the preferred forms shown in FIGS. 1-14, the outer operational device further includes a mover 42 having a circular hole 420. Mover 42 includes a limiting bar 426 extending upward along second axis Y from an upper end thereof and an actuating bar 424 extending downward along second axis Y from a lower end thereof. A tab 422 extends perpendicularly from actuating bar 424 along first axis X. Mover 42 is rotatably mounted around body 264.

According to the preferred forms shown in FIGS. 1-14, the outer operational device further includes a lid 40 in the form of a thin shell. Specifically, lid 40 includes two lateral walls 410 extending along second axis Y and spaced along third axis Z and an interconnecting wall 412 interconnected between lateral walls 410. A hole 402 is defined in interconnecting wall 412 and has a shape corresponding to body 264 of cylinder 26. Two diametrically opposed projections 406 are formed on an inner periphery of hole 402. Interconnecting wall 412 further includes an arcuate limiting groove 404 below hole 402. Lid 40 further includes an upper notch 408 in a top thereof between upper ends of lateral walls 410 and a lower notch 408 in a bottom thereof between lower ends of lateral walls 410. Lid 40 is mounted around body 264 of cylinder 26 with projections 406 engaged in positioning grooves 268 and with lateral walls 410 abutting chamfered faces 209 of receiving portion 205, so that cylinder 26 can not rotate and that lid 40 can not rotate relative to receiving portion 205. A washer 274 with inner threading is threadedly engaged around threaded portion 266 and abuts a face of interconnecting wall 412 of lid 40, preventing lid 40 from moving along first axis X. Furthermore, mover 42 is rotatably mounted between cover 20 and washer 274.

Limiting bar 426 of mover 42 extends beyond upper notch 408 of lid 40 along second axis Y, and actuating bar 424 extends beyond lower notch 408 of lid 40 along second axis Y. Furthermore, tab 422 of mover 42 extends beyond limiting groove 404 of lid 40 along first axis X. Thus, rotational movement of mover 42 is limited by notches 408 and limiting groove 404. Actuating bar 424 is located between first and second protruded portions 330 and 332 of limiting member 32. Tab 422 is located in a path of rotational movement of actuator 272 of cylinder 26, so that mover 42 rotates when actuator 272 comes in contact with and drives tab 422.

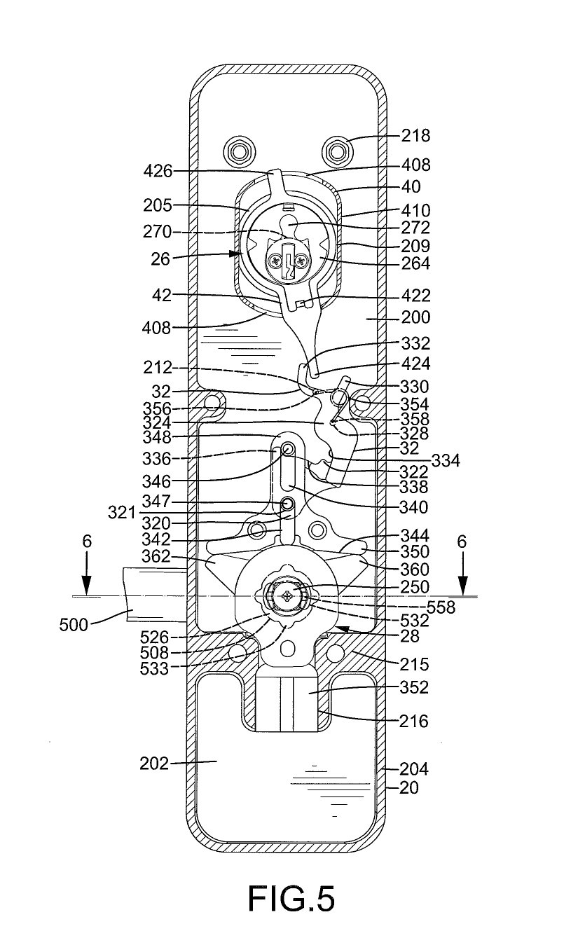

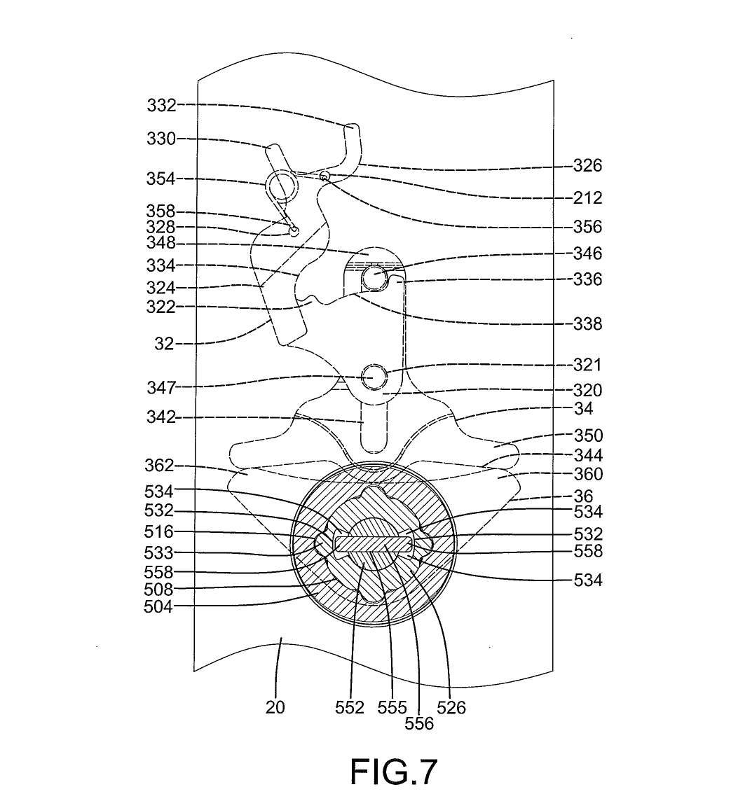

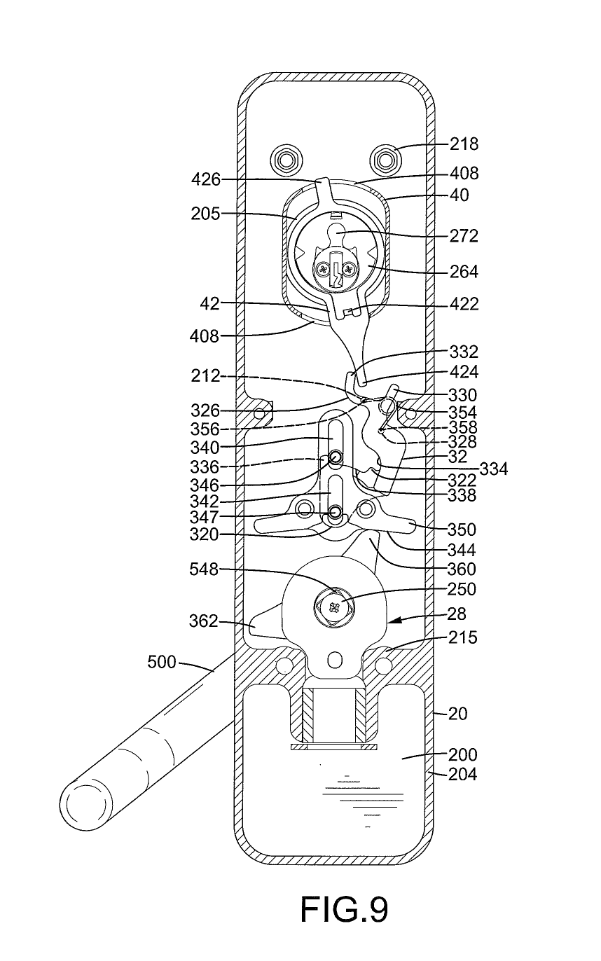

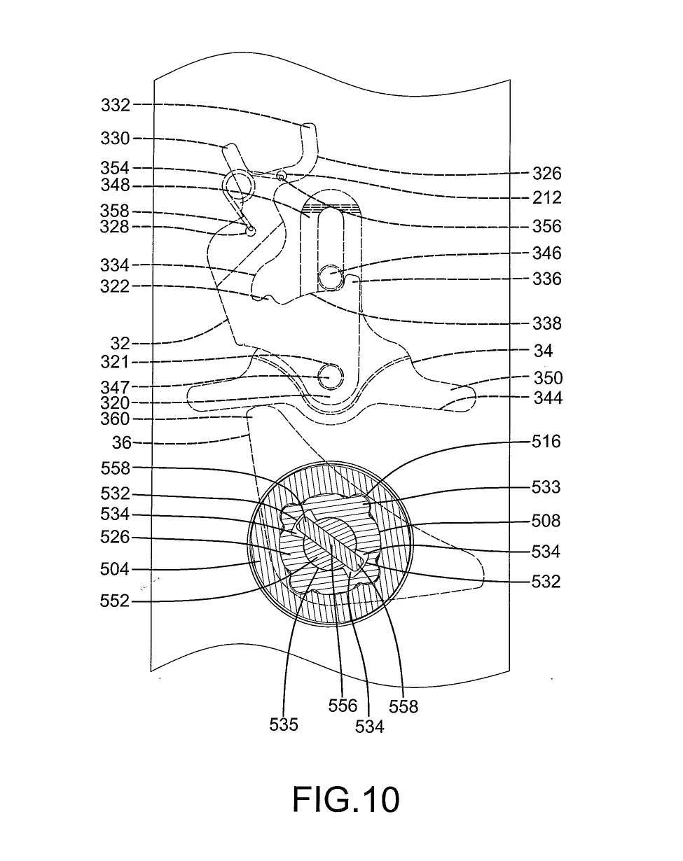

Now that the basic construction of outer handle device 50 of the preferred teachings of the present invention has been explained, the operation and some of the advantages of outer handle device 50 can be set forth and appreciated. In particular, for the sake of explanation, it will be assumed that door 10 is closed but not in a locked state with operative member 162 not operated and with outer handle 500 in a first, horizontal position perpendicular to second axis Y (FIGS. 4, 5, and 7). Sliding member 34 is in the lower position (FIG. 5) and positions first and second ends 360 and 362 of actuating member 36 in a plane perpendicular to second axis Y. Second limiting portion 336 of limiting member 36 abuts first guide pine 346 and is biased by spring 354 to a release position (FIGS. 5 and 7). In this state, the moving path of sliding member 34 is not blocked by limiting member 32. Thus, when outer handle 500 is rotated to a second position (FIG. 9), follower 38 and rotatable member 280 of returning device 28 rotate jointly with coupling section 548 of spindle 538 that rotates jointly with outer handle 500, so that first block 286 moves second tang 316 of elastic element 312 and that elastic element 312 is twisted to store potential energy for returning purposes. Actuating member 36 is driven by follower 38 to rotate in a direction. When outer handle 500 is rotated counterclockwise, first end 360 of actuating member 36 rotates upward from a lower position shown in FIG. 5 along second axis Y to an upper position shown in FIGS. 9 and 10 whereas second end 362 of actuating member 36 rotates downward. First end 360 of actuating member 36 presses against pressing face 344 of sliding member 34, so that sliding member 34 move upward along first and second guide pins 346 and 347. At the same time, driving member 44 is carried upward by sliding member 34. When first block 286 is rotated from its initial position to an extreme position abutting against one of ends 306 of the other limiting block 304, driving member 44 is moved from the lower position to the upper position where stem 502 of outer handle 500 is at an angle of 45° with the horizontal plane perpendicular to second axis Y.

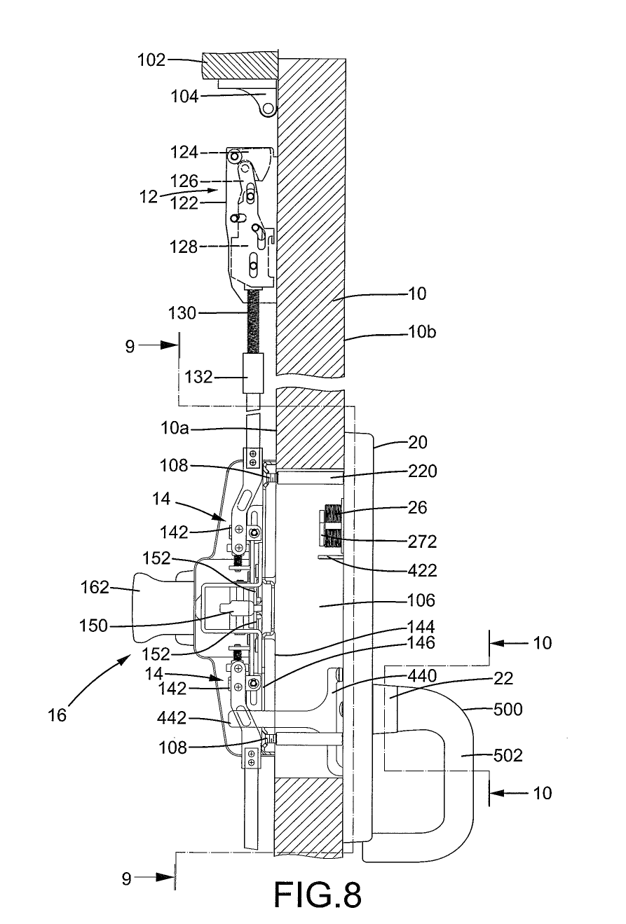

During movement of driving member 44 from the lower position to the upper position, lower slide 142 of follower device 16 is pressed against and, thus, moved by rod 442 of mover 42. Slides 142 pull coupling rods 132 and screw rods 130 in the vertical direction, which in turn, move followers 128 and connecting rods 16 to pivot latches 124 to the unlatching positions (FIG. 8), allowing opening of door 10.

When outer handle 500 is released after unlatching, second tang 316 of elastic element 312 returns rotatable member 280 from the extreme position back to the initial position, which in turn, rotates outer handle 500 in a clockwise direction in FIG. 9 to its initial position via coupling section 548 of spindle 538. Thus, stem 502 of outer handle 500 returns to its horizontal position, and first and second ends 360 and 362 of actuating member 36 are at the same level. At the same time, sliding member 34 moves downward under the action of gravitational force until first and second ends 360 and 362 of actuating member 36 simultaneously abut pressing face 344. Furthermore, driving member 44 is carried by sliding member 34 to the lower position. Slides 142 of follower device 16 are returned by a returning device of latch device 12 to positions shown in FIG. 4.

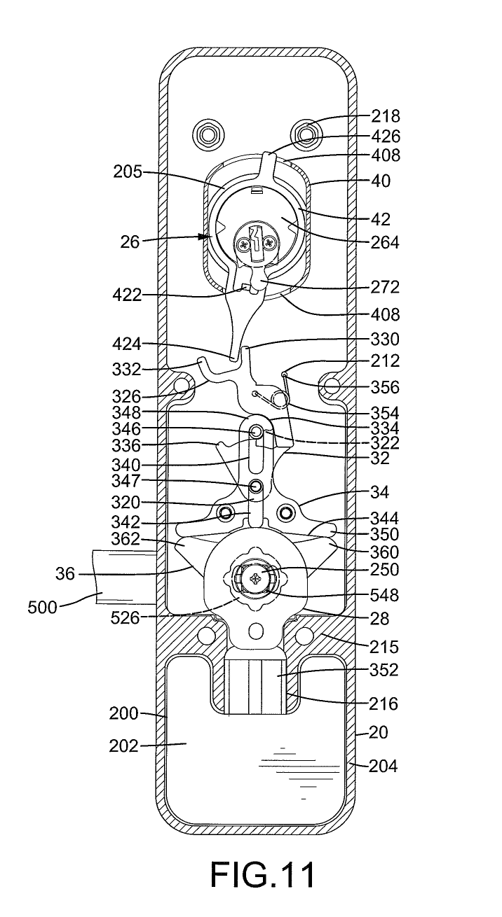

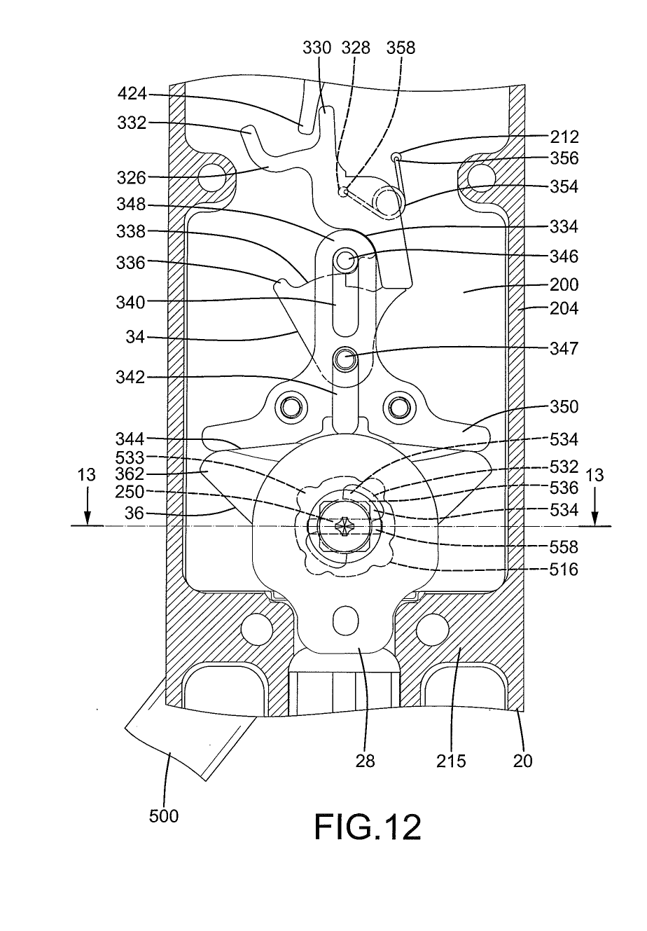

When the door lock is in a state shown in FIG. 5, a key can be inserted into lock core 270 in cylinder 26 to rotate lock core 270, so that actuator 272 is rotated to press against tab 422 of mover 42 in a clockwise direction in FIG. 5. Tab 422 of mover 42 pushes second protruded portion 332 of limiting member 32 so that stop 324 of limiting member 32 rotates toward first section 348 of sliding member 34 until stop 324 abuts on top of first section 348 of sliding member 34. In this case, limiting member 32 is in a blocking position (FIGS. 11 and 12). Furthermore, when limiting member 32 rotates, second tang 358 of spring 354 rotates about a pivot axis defined by first tang 356 to a position retaining limiting member 32 in the blocking position. Movement of sliding member 34 is blocked by limiting member 32 so that actuating member 36 and follower 38 can not rotate. Thus, spindle 538 can not be rotated. In this state, unlocking can not be achieved through operation of outer handle 500.

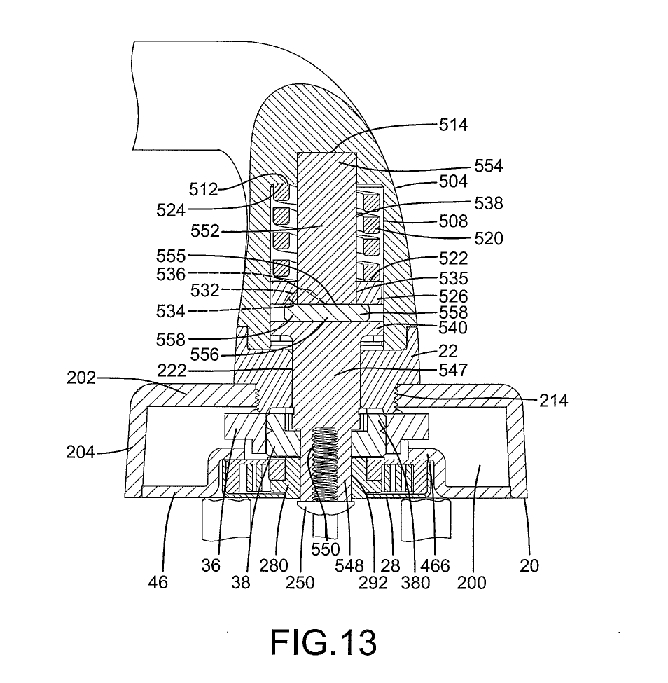

Specifically, when the door lock is in a state shown in FIG. 11, if force applied to rotate outer handle 500 is large enough to overcome spring 520, clutch block 526 rotates jointly with outer handle 500. At the same time, engaging grooves 532 of clutch block 526 are disengaged from protrusions 558, as shown in FIG. 12. Note that protrusions 558 presses against inclined faces 534 of engaging grooves 532 and, thus, push clutch block 526 toward end wall 512 along first axis X and compresses spring 520. When outer handle 500 reaches the second position (FIG. 9), protrusions 558 press against front face 528 of clutch bock 526, as shown in FIG. 13. Thus, outer handle 500 can not drive spindle 538 to rotate. Namely, outer handle 500 and clutch block 526 rotates jointly and freely. When outer handle 500 is rotated again to a position where engaging grooves 532 are aligned with protrusions 558, clutch block 526 is pushed by spring 520 toward flange 540 to engage engaging grooves 532 with protrusions 558. It can be appreciated that outer handle 500 can be rotated back to the first position shown in FIG. 5 without rotating spindle 538.

Since the force required to overcome spring 520 is smaller than the force sufficient to damage the internal components of the door lock including limiting member 32, sliding member 34, first guide pin 346, actuating member 36, and follower 38, the risk of damage to the internal components is avoided when outer handle 500 is rotated while spindle 538 of the door lock is in a locked state. The service life of the door lock is, thus, prolonged while avoiding unnecessary repair.

Now that the basic teachings of the present invention have been explained, many extensions and variations will be obvious to one having ordinary skill in the art. For example, engaging grooves 532 can be formed in second surface 544 of flange 540, and protrusions 558 can be formed on front face 528 of clutch block 526. Furthermore, spindle 538 can include protrusions 558 formed on an outer periphery of rear spindle section 552 adjacent flange 540 without including pin hole 555 and pin 556. Further, clutch mechanism 52 can include only one engaging groove 532 or more than two engaging grooves 532 and a corresponding number of protrusions 558. Further, spindle 538 does not have to include rear spindle section 552. Namely, flange 540 is located on an end of front spindle section 546 of spindle 538, and pin 556 is fixed to flange 540 (or protrusions 558 are directly formed on second surface 544 of flange 540). In this case, clutch block 526 does not have to include through-hole 535. Rotation of outer handle 500 while spindle 538 is in a locked state will not move spindle 538 toward end wall 512 along first axis X under the action of spring 538. Thus, spindle 538 can still operate without rear spindle section 552. Further, stop 560 can be in the form of a peg or protrusion abutting first surface 542 of flange 540 without adversely affecting operation of spindle 538. The number of guide grooves 516 and lugs 533 can be varied according to design needs. Further, end wall 512 of chamber 508 does not have to include receptacle 514, and distal end 554 of rear spindle section 552 can abut end wall 512 to achieve the same function of preventing spindle 538 from moving towards 512 along first axis X.

It can be appreciated that outer handle device 50 according to the preferred teachings of the present invention can be utilized with any suitable operational device. Furthermore, coupling portion 548 of spindle 538 of outer handle device 50 according to the preferred teachings of the present invention can be utilized with door locks of other types.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An outer handle device for a door lock, comprising, in combination:
an outer handle (500) including a shank (504) extending along an axis (X) and having an end face (506), with a chamber (508) formed in the end face (506) and having an opening (510) in the end face (506), with the chamber (508) including an end wall (512) spaced from the opening (510) along the axis (X), with the end face (506) of the shank (504) adapted to rotatably abut an outer face of a cover (20) mounted to an outer side (10b) of a door (10) to which the door lock is mounted, with the outer handle (500) rotatable between first and second positions;
a spring (520) received in the chamber (508), with the spring (520) including front and rear ends (522, 524) spaced along the axis (X), with the rear end (524) of the spring (520) abutting the end wall (512) of the chamber (508);
a clutch block (526) slideably received in the chamber (508) along the first axis (X) but not rotatable relative to the outer handle (500) about the axis (X), with the clutch block (526) including front and rear faces (528, 530) spaced along the axis (X), with the front end (522) of the spring (520) abutting the rear face (530) of the clutch block (526), with the clutch block (526) rotating jointly with the outer handle (500) when the outer handle (500) rotates between the first and second positions;
a spindle (538) rotatably received in the chamber (508) about the axis (X), with the spindle (538) including a front spindle section (546), with a coupling section (548) formed on an end of the front spindle section (546), with the coupling section (548) adapted to be operably connected to a latch (124) of the door lock, with a flange (540) formed on another end of the front spindle section (546) and spaced from the coupling section (548) along the axis (X), with the flange (540) including first and second surfaces (542, 544) spaced along the axis (X), with the latch (124) adapted to be in a latching position when the spindle (538) is in an unlocked, rotatable state and when the handle (500) is in the first position, with the spindle (538) being moved by the outer handle (500) to move the latch (124) to an unlatching position when the outer handle (500) is rotated from the first position to the second position;
a clutch mechanism (52) including a protrusion (558) and an engaging groove (532), with the protrusion (558) formed on one of the front face (528) of the clutch block (526) and the other end of the spindle (538), with the engaging groove (532) formed in the other of the front face (528) of the clutch block (526) and the other end of the spindle (538), with the protrusion (558) releasably engaged in the engaging groove (532); and
a stop (560) received in the opening (510) of the chamber (508), with the stop (560) abutting the flange (540) to prevent the spindle (538) from moving away from the end wall (512) along the axis (X);
wherein when the spindle (538) is in the unlocked, rotatable state, the protrusion (558) is engaged in the engaging groove (532) while the outer handle (500) is rotated from the first position to the second position, the clutch block (526) rotates jointly with the outer handle (500) about the axis (X) and drives the spindle (538) to rotate about the axis (X), moving the latch (124) from the latching position to the unlatching position, and
wherein when the spindle (538) is in a locked, not rotatable state, the clutch block (526) rotates jointly with the outer handle (500) while the outer handle (500) is rotated from the first position to the second position, the clutch block (526) also slides relative to the outer handle (500) towards the end wall (512) along the axis (X) to disengage the protrusion (558) from the engaging groove (532), disengaging the clutch block (526) from the spindle (538) such that the spindle (538) is not rotated and that the latch (124) remains in the latching position.

2. The outer handle device as claimed in claim 1, with the protrusion (558) formed on the second surface (544) of the flange (540), with the engaging groove (542) formed in the front face (528) of the clutch block (526).

3. The outer handle device as claimed in claim 2, with the clutch block (526) including a through-hole (535) extending from the front face (528) through the rear face (530) of the clutch block (526), with the spindle (538) further including a rear spindle section (552), with the flange (540) intermediate the front and rear spindle sections (546, 552), with the rear spindle section (538) extending through the through-hole (535) of the clutch block (526) and abutting the end wall (512), preventing the spindle (538) from moving towards the end wall (512) along the axis (X).

4. The outer handle device as claimed in claim 3, with the chamber (508) including an inner periphery having an annular groove (518) adjacent the opening (510), with the stop (560) including a ring received in the annular groove (518), with the flange (540) intermediate the ring and the clutch block (526) along the axis (X), and with the ring receiving the rear spindle section (538).

5. The outer handle device as claimed in claim 4, with the inner periphery of the chamber (508) further including a guide groove (516) extending from the opening (510) towards the end wall (512) along the axis (X) and intersecting the annular groove (518), with the clutch block (526) further including an outer periphery (531) extending between the front and rear faces (528, 530), with a lug (533) formed on the outer periphery (531) of the clutch block (526), with the lug (533) slideably received in the guide groove (516) along the axis (X) such that the clutch block (526) is slideably received in the chamber (508) along the axis (X) but not rotatable in the chamber (508) about the axis (X).

6. The outer handle device as claimed in claim 1, with the spindle (538) further including a rear spindle section (552), with the flange (540) intermediate the front and rear spindle sections (546, 552), with the front and rear spindle sections (546, 552 respectively facing the first and second surfaces (542, 544) of the flange (540), with the rear spindle section (552) including a pin hole (555) extending perpendicularly to the axis (X), with a pin (556) extending through the pin hole (555) and having an end outside of the pin hole (555) and forming the protrusion (558), with the engaging groove (532) including a bottom wall (536) spaced from the front face (528) of the clutch block (526), with the engaging groove (532) further including an inclined face (534) extending between the bottom wall (536) and the front face (528) of the clutch block (526),
wherein when the spindle (538) is in the locked, not rotatable state, the protrusion (558) moves along and presses against the inclined face (534) while the outer handle (500) is rotated from the first position to the second position, moving the clutch block (526) towards the end wall (512) along the axis (X) to disengage the protrusion (558) from the engaging groove (532), such that the spindle (538) is not rotated.

7. The outer handle device as claimed in claim 6, with the clutch block (526) including a through-hole (535) extending from the front face (528) through the rear face (530) of the clutch block (526), with the rear spindle section (552) extending through the through-hole (535) of the clutch block (526) and abutting the end wall (512), preventing the spindle (538) from moving towards the end wall (512) along the axis (X).

8. The outer handle device as claimed in claim 7, with the with the chamber (508) including an inner periphery having an annular groove (518) adjacent the opening (510), with the stop (560) including a ring received in the annular groove (518), with the flange (540) intermediate the ring and the clutch block (526) along the axis (X), and with the ring receiving the rear spindle section (552).

9. The outer handle device as claimed in claim 8, with the inner periphery of the chamber (508) further including a guide groove (516) extending from the opening (510) towards the end wall (512) along the axis (X) and intersecting the annular groove (518), with the clutch block (526) further including an outer periphery (531) extending between the front and rear faces (528, 530), with a lug (533) formed on the outer periphery (531) of the clutch block (526), with the lug (533) slideably received in the guide groove (516) along the axis (X) such that the clutch block (526) is slideably received in the chamber (508) along the axis (X) but not rotatable in the chamber (508) about the axis (X).
